(19) United States
(12) Patent Application Publication
(10) Pub. No.: US 2022/0251983 A1
(43) Pub. Date: Aug. 11, 2022

(54) ENGINE OIL RECEIVING STRUCTURE

(71) Applicant: HONDA MOTOR CO., LTD., Tokyo (JP)

(72) Inventors: Masayoshi Kawaguchi, Wako-shi (JP); Yoshio Ikeda, Wako-shi (JP); Hirosuke Niwa, Wako-shi (JP)

(21) Appl. No.: 17/579,146

(22) Filed: Jan. 19, 2022

(30) Foreign Application Priority Data
Feb. 5, 2021 (JP) 2021-017808

(51) Int. Cl. F01M 11/03; F01M 11/00; F01M 11/02; F01M 11/04; B63H 21/38

(52) U.S. Cl. CPC F01M 11/03; F01M 11/0004; B63H 21/386; F01M 11/04; F01M 11/02

(57) ABSTRACT

An engine oil receiving structure comprises a vertically disposed crank shaft, a laterally movable piston, a connecting rod connecting the crank shaft and the piston, a cylinder barrel housing the crank shaft and the piston, a crank case containing the crank shaft together with the cylinder barrel, a cylinder head forming a combustion chamber, the combustion chamber connecting to a piston movable part end face of the cylinder barrel, an oil filter filtering engine lubricant, and an oil case storing oil flowing out when the oil filter is removed from a mounted position, and the oil case is fixed to an engine under the oil filter, and comprises a discharge path to discharge the stored oil.

### INCORPORATION BY REFERENCE

The present application claims priority under 35 U.S.C. § 119 to Japanese Patent Application No. 2021-017808 filed on Feb. 5, 2021. The content of the application is incorporated herein by reference in its entirety.

### BACKGROUND OF THE INVENTION

### Field of the Invention

The present invention relates to an engine oil receiving structure.

### Description of the Related Art

Heretofore, an outboard motor comprises an engine and an oil filter that filters engine oil (e.g., Japanese Patent Laid-Open No. 11-107732). As a mounting direction of the oil filter onto this outboard motor, a lateral direction is adopted. In the present structure, residual oil in an oil passage and the oil filter flows out during replacement and maintenance of the oil filter.

To solve the problem, in the conventional outboard motor, eaves are installed under a mounting part of the oil filter, and a range of oil dripping is suppressed, to prevent oil from scattering around.

In a conventional technology, oil can be prevented from scattering around, but cleaning with waste cloth or the like is finally required.

In recent years, with increase in size of an outboard motor and increase of multi-machine boats, it has been desired to increase efficiency of replacement and maintenance of an oil filter.

To solve the problem, an object of the present invention is to provide an engine oil receiving structure in which an oil filter can be replaced without outflow of oil to outside.

### SUMMARY OF THE INVENTION

An aspect of the present invention provides an engine oil receiving structure comprising a vertically disposed crank shaft, a laterally movable piston, a connecting rod connecting the crank shaft and the piston, a cylinder barrel housing the crank shaft and the piston, a crank case containing the crank shaft together with the cylinder barrel, a cylinder head forming a combustion chamber, the combustion chamber connecting to a piston movable part end face of the cylinder barrel, an oil filter filtering engine lubricant, and an oil case storing oil flowing out when the oil filter is removed from a mounted position, wherein the oil case is fixed to an engine under the oil filter, and comprises a discharge path to discharge the stored oil.

According to another aspect of the present invention, in the above engine oil receiving structure, the crank case is formed with an oil guide, and the oil case is fixed to the oil guide.

According to still another aspect of the present invention, in the engine oil receiving structure, the oil case comprises the discharge path in a bottom part of the oil case.

According to a further aspect of present invention, in the engine oil receiving structure, the discharge path comprises a drain cock.

According to a further aspect of the present invention, in the engine oil receiving structure, the discharge path has a tip comprising a closing cap.

According to a further aspect of the present invention, the engine oil receiving structure further comprises a connecting component between the cap and the oil case.

According to a further aspect of the present invention, in the engine oil receiving structure, the discharge path has a bellows shape.

According to a further aspect of the present invention, in the engine oil receiving structure, the oil case is tightened together with an oil receiving ring.

According to a further aspect of the present invention, in the engine oil receiving structure, the engine has an upper part being covered with an upper engine cover, and the oil case is disposed inside the upper engine cover.

According to a further aspect of the present invention, in the engine oil receiving structure, the oil case has a bottom part being provided with a groove.

A further aspect of present invention provides an outboard motor comprising the engine oil receiving structure according to any one of the above aspects.

A still further aspect of present invention provides a ship comprising the above outboard motor.

According to aspects of the present invention, an oil filter can be replaced without outflow of oil to outside.

### BRIEF DESCRIPTION OF THE DRAWINGS

FIG. 1 is a starboard side view showing an entire outboard motor;

FIG. 2 is a partially cross-sectional view of an upper part of the outboard motor seen from a starboard side;

FIG. 3 is a perspective view showing a state where an oil filter is mounted;

FIG. 4 is a side view showing the mounted state of the oil filter;

FIG. 5 is a perspective view showing a mounted state of an oil filter of a first modification;

FIG. 6 is a perspective view showing an oil receiving ring;

FIG. 7 is a perspective view showing a mounted state of an oil filter of a second modification;

FIG. 8 is a side view of a projecting part; and

FIG. 9 is a perspective view showing a mounted state of an oil filter of a third modification.

### DETAILED DESCRIPTION OF THE PREFERRED EMBODIMENT

Hereinafter, an embodiment of the present invention will be described with reference to the accompanying drawings.

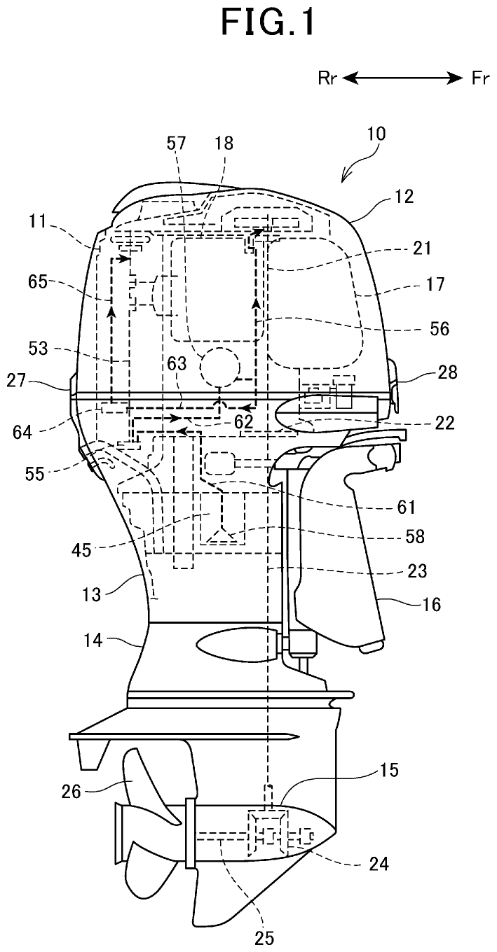

FIG. 1 is a side view of an outboard motor 10 on a starboard side. FIG. 1 shows a main internal mechanism with a dashed line. A direction of an arrow Fr indicates front, and a direction of an arrow Rr indicates rear.

The outboard motor 10 comprises an engine 11 in an upper part. The engine 11 is covered with an upper engine cover 12 and a lower engine cover 13. The upper engine cover 12 is mounted on an upper end of the lower engine cover 13 with a rear hinge 27 and a front stopper 28. A stern bracket 16 is provided in front of the lower engine cover 13. The outboard motor 10 can be mounted on a hull with the stern bracket 16. An extension cover 14 is provided under the lower engine cover 13, and a gear case 15 is provided under the extension cover 14.

Inside the upper engine cover 12, an intake silencer 17 is disposed in front of the engine 11. The intake silencer 17 introduces air (fresh air) into an engine intake port. An electrical component 18 is disposed behind the intake silencer 17. The electrical component 18 performs ignition control of the engine 11, control of a fuel injection device and the like.

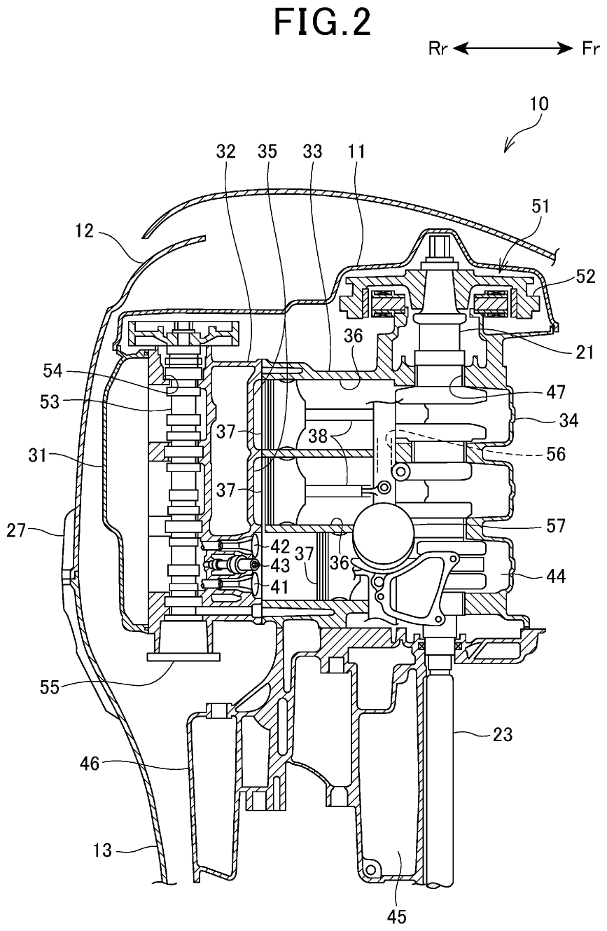

FIG. 2 is a partially cross-sectional view of the upper part of the outboard motor 10 seen from a starboard side.

As shown in FIG. 2, the engine 11 comprises a rear cylinder head cover 31, a laterally connecting cylinder head 32, a further laterally connecting cylinder block 33, and a front crank case 34. The cylinder head 32 comprises a combustion chamber 35. The cylinder block 33 comprises a plurality of laterally oriented cylinder barrels 36, and in each of the cylinder barrels 36, a laterally oriented piston 37 is laterally (front-rear direction) slidably provided. The piston 37 has a piston movable part end face being connected to the combustion chamber 35.

A crank shaft 21 is rotatably connected to each piston 37 via a connecting rod 38. The crank shaft 21 is vertically disposed, and supported by a bearing 47. The crank shaft 21 is contained in the crank case 34. The crank shaft 21 has an upper end connected to a power generation mechanism 51 and a recoil starter 52. As shown in FIG. 1, a flywheel 22 is mounted on a lower end of the crank shaft 21. Also, the lower end of the crank shaft 21 is coupled to a drive shaft 23. The drive shaft 23 passes inside the lower engine cover 13 and the extension cover 14, and is coupled to a power transmission mechanism 24 in the gear case 15.

The power transmission mechanism 24 transmits power of the drive shaft 23 to a horizontal driven shaft 25. The driven shaft 25 protrudes rearward from the gear case 15, and has a rear end to which a propeller 26 is secured. In the outboard motor 10, a pair of dog clutches (not shown) are switched, to switch forward rotation and backward rotation of the propeller 26, thereby obtaining propulsion for forward or backward movement.

As shown in FIG. 2, the engine 11 comprises a vertically oriented cam shaft 53. The cam shaft 53 is supported by a bearing 54 of the cylinder head 32. The cam shaft 53 has a lower end connected to an oil pump 55, and the oil pump 55 is operated with a rotational force of the cam shaft 53. Also, the engine 11 comprises an intake valve 41, an exhaust valve 42, and an ignition plug 43.

Inside the crank case 34, a crank chamber 44 is formed. Under the crank chamber 44, an oil pan 45 is disposed, and in such a structure, oil (engine lubricant) in the crank chamber 44 flows down into the oil pan 45. The engine 11 has a lower part in which a mount case 46 supporting the engine 11 is disposed.

In the vicinity of the cylinder block 33, a main gallery 56 of an oil passage is disposed. An oil filter 57 is provided in a middle of the main gallery 56.

As shown with dashed arrows in FIG. 1, oil in the oil pan 45 is pumped up from a strainer 58 via an oil path 61 with an oil pump 55. The oil pumped up passes from the oil pump 55 through an oil path 62, and is filtered through the oil filter 57. The filtered oil branches and flows upward and downward via the main gallery 56.

The oil in the main gallery 56 is supplied to the bearing 47 of the crank shaft 21 and the like. The oil branching from the main gallery 56 to an oil branch path 63 is supplied via a spool valve 64 and an oil path 65 to the bearing 54 of the cam shaft 53 and the like.

Next, an engine oil receiving structure will be described.

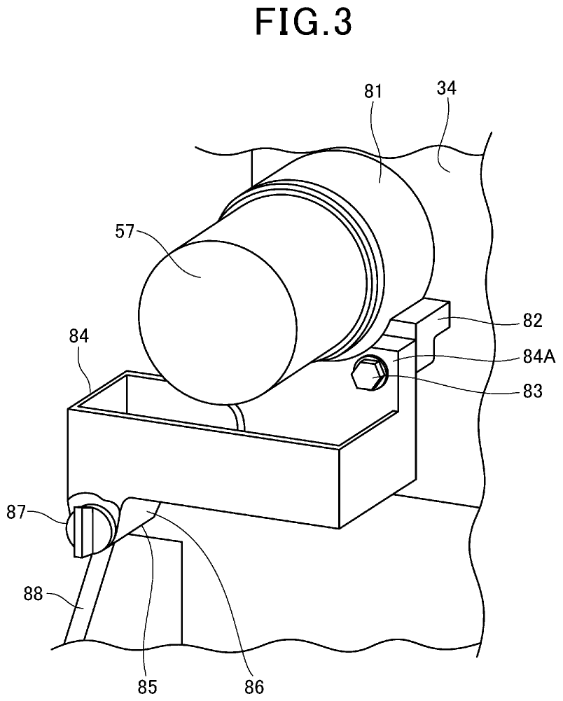

FIG. 3 is a perspective view showing a state where the oil filter 57 is mounted.

As shown in FIG. 3, the oil filter 57 is laterally oriented and mounted on a side part of the crank case 34. The crank case 34 has a side surface being formed with a ring-shaped boss part 81, and the oil filter 57 is fitted inside a boss part 81.

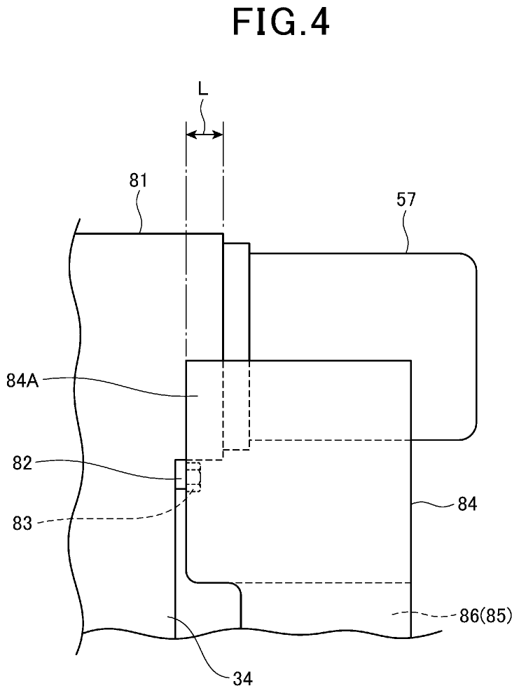

FIG. 4 is a side view showing the mounted state of the oil filter 57.

On opposite sides of a lower end of the boss part 81, a pair of oil guides 82 are formed, and on each of the oil guides 82, an ear piece 84A of a box-shaped oil case 84 is mounted with a mounting bolt 83. As shown in FIG. 4, the oil case 84 is fixed to the side part of the crank case 34 under the oil filter 57. The oil case 84 is mounted to extend inward by a predetermined dimension L, for example, about 16 mm behind a tip of the boss part 81. A protruding dimension of the positioned oil guide 82 can be determined by assuming a position where oil drops down from the oil filter 57 into the oil case 84. Furthermore, the oil guide 82 can simplify a fixing structure of the oil filter 57, and the oil case 84 can include a simplified structure.

The oil case 84 stores oil flowing out when the oil filter 57 is removed from a mounted position. The oil case 84 is provided with a lowered bottom part 85 on a left side in FIG. 3. The bottom part 85 of the oil case 84 is provided with a discharge path 86 to discharge the stored oil. The discharge path 86 comprises a drain cock 87 and a discharge hose 88. The discharge hose 88 may be a hose having a bellows shape. The oil case 84 may have the bottom part being provided with a groove.

Consequently, the oil is efficiently collected in the oil case 84.

The oil filter 57 needs to be periodically replaced. During the operation of the engine 11, as shown with dashed arrows in FIG. 1, the oil in the oil pan 45 is pumped up with the oil pump 55, is filtered through the oil filter 57, and flows upward and downward via the vertically oriented main gallery 56. When the engine 11 is stopped, the oil pump 55 is also stopped, but oil remains in the main gallery 56. During the replacement of the oil filter 57, the oil remaining in the main gallery 56 flows out.

In the present embodiment, since the oil case 84 is mounted on the side part of the crank case 34 under the oil filter 57, the oil flowing out during the replacement of the oil filter 57 is collected in the oil case 84. At this time, the drain cock 87 of the discharge path 86 is closed. Therefore, in the outboard motor 10 of the present embodiment, the oil filter 57 can be replaced without outflow of oil to outside. Since the oil case 84 is mounted to extend inward by the predetermined dimension L, for example, about 16 mm behind the tip of the boss part 81, almost all the oil can be collected in the oil case 84.

In the bottom part 85 of the oil case 84, the discharge path 86 is provided, and hence the stored oil received in the oil case 84 can be discharged only by connecting a tip of the discharge hose 88 to an external container (not shown). Since the discharge path 86 is provided with the drain cock 87, the stored oil in the oil case 84 can be discharged by manually opening and closing the drain cock 87. The discharge hose 88 having the bellows shape may facilitate the connecting of the tip of the discharge hose 88 to the external container (not shown), which can decrease the number of working steps. Furthermore, the engine 11 has an upper part being covered with the upper engine cover 12, and the oil case 84 is disposed inside the upper engine cover 12. Consequently, the oil case 84 is housed in the upper engine cover 12, which avoids interference with another component and the like.

Next, description will be made as to modifications of the present embodiment.

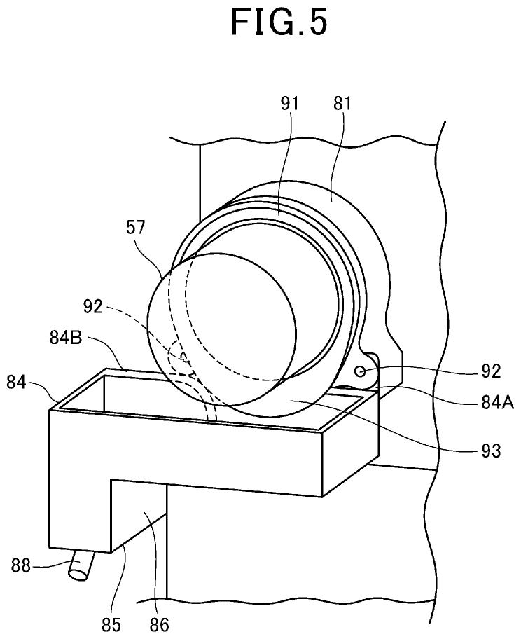

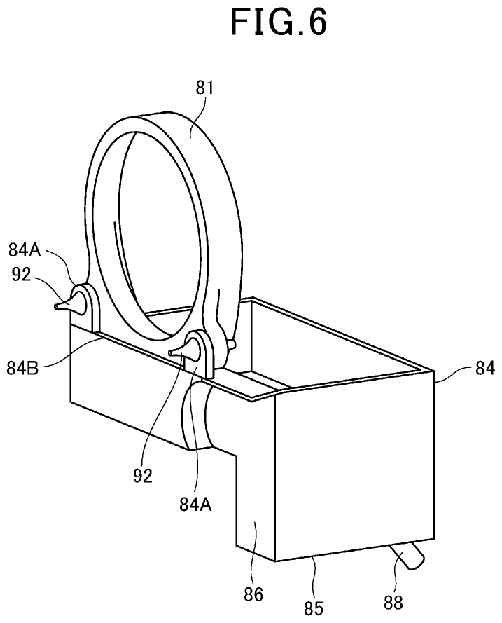

FIG. 5 is a perspective view showing a mounted state of an oil filter 57 of a first modification. FIG. 6 is a perspective view showing an oil receiving ring 91. Note that the same part as in FIG. 3 is denoted with the same reference sign in FIGS. 5 and 6, and is not described.

In the present modification, the oil receiving ring 91 made of a rubber is mounted on an outer circumference of the boss part 81. As shown in FIG. 6, the oil receiving ring 91 comprises a pair of projecting parts 92. The projecting parts 92 fit in holes of ear pieces 84A of an oil case 84, respectively, and the oil receiving ring 91 is clamped on the oil case 84.

The oil case 84 is tightened together with the oil receiving ring 91. Around a lower part of the oil receiving ring 91, as shown in FIG. 5, a tongue-shaped part 93 protruding forward is formed. The tongue-shaped part 93 extends into the oil case 84.

In this modification, since the oil case 84 is tightened together with the oil receiving ring 91, oil does not fly or scatter during replacement of the oil filter 57. Since the tongue-shaped part 93 of the oil receiving ring 91 extends into the oil case 84, oil flowing out during the replacement of the oil filter is efficiently collected in the oil case 84. Therefore, in an outboard motor 10 of the present modification, the oil filter 57 can be replaced without outflow of oil to outside.

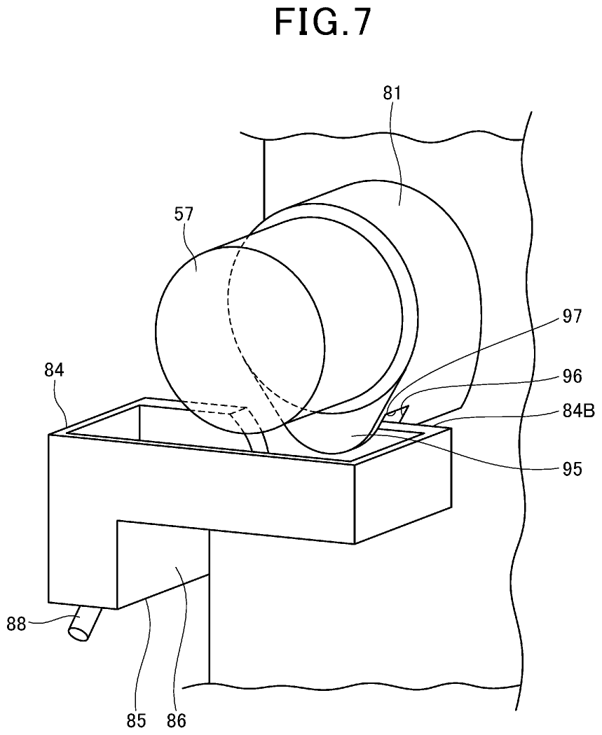

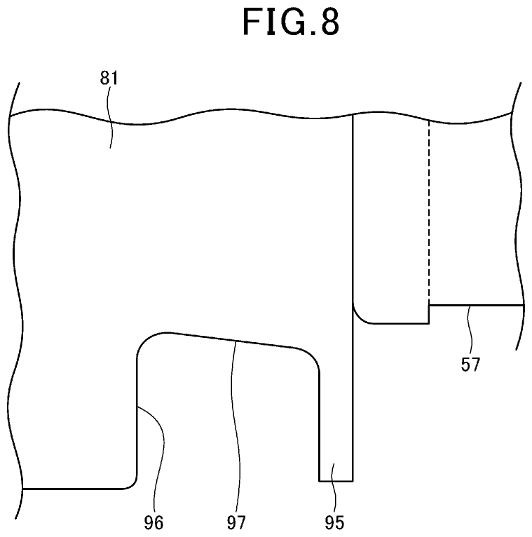

FIG. 7 is a perspective view showing a mounted state of an oil filter 57 of a second modification. FIG. 8 is a side view of a projecting part 95. Note that the same part as in FIG. 3 is denoted with the same reference sign in FIGS. 7 and 8, and is not described.

In the present modification, a boss part 81 comprises the projecting part 95 around a lower part of the boss part 81. The projecting part 95 extends in a depth direction of the boss part 81. On a lower side of the projecting part 95, as shown in FIG. 8, an oil receiving groove 96 is formed. The oil receiving groove 96 extends in a circumferential direction. An oil case 84 has an edge 84B extending into the oil receiving groove 96. The oil receiving groove 96 has a top 97 being inclined downward to the oil case 84.

In this modification, since the edge 84B of the oil case 84 extends into the oil receiving groove 96 of the projecting part 95, oil flowing out during replacement of the oil filter is efficiently collected in the oil case 84. Since the top 97 of the oil receiving groove 96 is inclined downward to the oil case 84, oil entering the oil receiving groove 96 does not fly or scatter around, and the oil is efficiently collected in the oil case 84. Therefore, in an outboard motor 10 of the present modification, the oil filter 57 can be replaced without outflow of oil to outside.

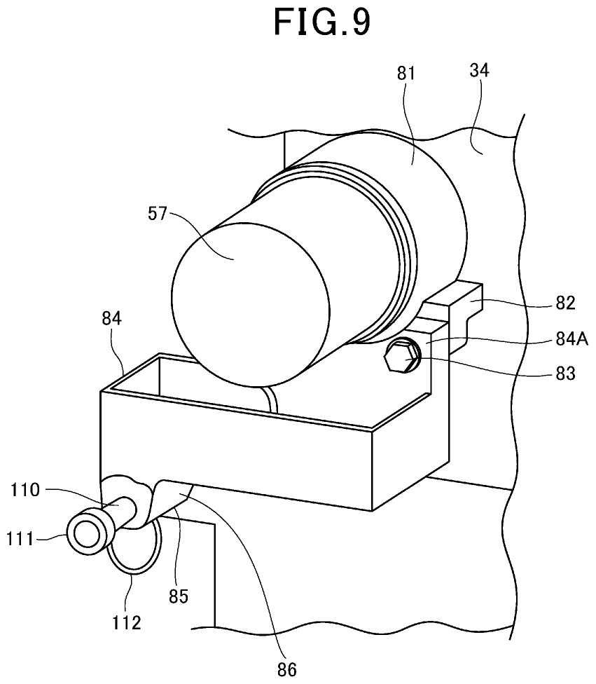

FIG. 9 is a perspective view showing a mounted state of an oil filter 57 of a third modification. The same part as in FIG. 3 is denoted with the same reference sign in FIG. 9, and is not described.

An oil case 84 has a bottom part 85 being provided with a discharge path 86 to discharge stored oil. The discharge path 86 comprises a discharge tube 110, and a cap 111 closing a tip of the discharge tube 110. The tip of the discharge tube 110 can be closed with the cap 111, to suppress oil leakage. The cap 111 and the bottom part 85 of the oil case 84 are connected with a connecting component 112 such as a metal wire. The cap 111 can be prevented from being lost.

The engine according to the present invention is applied to the vertical engine 11 in the above embodiment, but may be applied to a so-called transverse engine.

Any engine including the oil filter being mounted at the middle position of the oil passage can be applied to another engine.

### REFERENCE SIGNS LIST

10 outboard motor
11 engine
12 upper engine cover
13 lower engine cover
21 crank shaft
32 cylinder head
33 cylinder block
34 crank case
35 combustion chamber
36 cylinder barrel
37 piston
38 connecting rod
45 oil pan
55 oil pump
57 oil filter
61, 62 and 63 oil path
63 oil branch path
81 boss part
82 oil guide
84 oil case
87 drain cock
88 discharge hose
91 oil receiving ring
111 cap
112 connecting component

What is claimed is:

1. An engine oil receiving structure comprising:
a vertically disposed crank shaft,
a laterally movable piston,
a connecting rod connecting the crank shaft and the piston,
a cylinder barrel housing the crank shaft and the piston,
a crank case containing the crank shaft together with the cylinder barrel,
a cylinder head forming a combustion chamber, the combustion chamber connecting to a piston movable part end face of the cylinder barrel,
an oil filter filtering engine lubricant, and
an oil case storing oil flowing out when the oil filter is removed from a mounted position, wherein the oil case is fixed to an engine under the oil filter, and comprises a discharge path to discharge the stored oil.

2. The engine oil receiving structure according to claim 1, wherein the crank case is formed with an oil guide, and the oil case is fixed to the oil guide.

3. The engine oil receiving structure according to claim 1, wherein the oil case comprises the discharge path in a bottom part of the oil case.

4. The engine oil receiving structure according to claim 1, wherein the discharge path comprises a drain cock.

5. The engine oil receiving structure according to claim 1, wherein the discharge path has a tip comprising a closing cap.

6. The engine oil receiving structure according to claim 5, further comprising a connecting component between the cap and the oil case.

7. The engine oil receiving structure according to claim 1, wherein the discharge path has a bellows shape.

8. The engine oil receiving structure according to claim 1, wherein the oil case is tightened together with an oil receiving ring.

9. The engine oil receiving structure according to claim 1, wherein the engine has an upper part being covered with an upper engine cover, and the oil case is disposed inside the upper engine cover.

10. The engine oil receiving structure according to claim 1, wherein the oil case has a bottom part being provided with a groove.

11. An outboard motor comprising the engine oil receiving structure according to claim 1.

12. A ship comprising the outboard motor according to claim 11.
